(19) United States
(12) Patent Application Publication
(10) Pub. No.: US 2026/0253038 A1
(43) Pub. Date: Aug. 27, 2026

(54) MEETING SETTING SYSTEM, MEETING SETTING SERVER, AND MEETING SETTING METHOD

(71) Applicant: SHARP KABUSHIKI KAISHA, Osaka (JP)

(72) Inventor: Makoto TSUBOSAKA, Osaka (JP)

(21) Appl. No.: 19/545,251

(22) Filed: Feb. 20, 2026

(30) Foreign Application Priority Data
Feb. 27, 2025 (JP) 2025-029764

(51) Int. Cl. G06Q 10/109

(52) U.S. Cl. CPC G06Q 10/109

(57) ABSTRACT

A meeting setting system that receives setting for a meeting, the meeting setting system includes: a receiver that receives an input; a storage that stores schedule information in which an attendee of a meeting is associated with a time; an updater that updates the schedule information in accordance with a result of the reception by the receiver; a display that provides display related to the schedule information; and a display controller that controls the display provided by the display based on a display priority set for the schedule information.

### CROSS-REFERENCE TO RELATED APPLICATION

The present application claims priority from Japanese Application JP2025-029764, the content to which is hereby incorporated by reference into this application.

### BACKGROUND OF THE INVENTION

### 1. Field of the Invention

The present disclosure relates to a meeting setting system, a meeting setting server, a meeting setting method, and a recording medium that receive setting for a meeting.

### 2. Description of the Related Art

It is a common practice to employ an unmanned reception system using a robot or the like for a normal reception operation in a company or the like.

### SUMMARY OF THE INVENTION

A known reception system includes a visitor recognizer that recognizes a visitor, a responder recognizer that recognizes a responder responding to the visitor, a responder contact information storage that stores contact information of the responder, a notifier that issues, to the contact of the responder, a notification indicating arrival of the visitor, and a responder selector that selects a substitute responder related to the responder when the responder is absent. The notifier issues the notification to the substitute responder when the responder is absent.

Cumbersomeness has been desired to be reduced for users engaged in operations other than the reception operation. For example, for events involving a plurality of users such as meetings, a schedule is demanded to be collectively set for the sake of efficient management.

The present disclosure has been made to solve the above problem, and an object of the present disclosure is to provide a meeting setting system, a meeting setting server, a meeting setting method, and a recording medium enabling flexible reception of setting for meeting.

A meeting setting system that receives setting for a meeting according to the present disclosure includes: a receiver that receives an input; a storage that stores schedule information in which an attendee of a meeting is associated with a time; an updater that updates the schedule information in accordance with a result of the reception by the receiver; a display that provides display related to the schedule information; and a display controller that controls the display provided by the display based on a display priority set for the schedule information.

In the meeting setting system according to the present disclosure, the display controller may provide the time designated for the attendee of the meeting, in the display provided by the display.

In the meeting setting system according to the present disclosure, the setting for the meeting may include designation of mandatory attendance and optional attendance for the attendee of the meeting, and the display priority may be set to be high for a time for which the optional attendance is designated compared with a time for which the mandatory attendance is designated.

In the meeting setting system according to the present disclosure, the setting for the meeting may include designation of a substitute attendee related to the attendee of the meeting, and the display priority may be set to be high for a time for which the substitute attendee is designated, compared with a time for which the optional attendance is designated.

In the meeting setting system according to the present disclosure, the schedule information may include a notification destination associated with the attendee of the meeting, and the updater may include a notifier that issues a notification to the notification destination, when the updater updates the schedule information.

A meeting setting server that receives setting for a meeting according to the present disclosure includes: a receiver that receives an input; a storage that stores schedule information in which an attendee of a meeting is associated with a time; an updater that updates the schedule information in accordance with a result of the reception by the receiver; a display that provides display related to the schedule information; and a display controller that controls the display provided by the display based on a display priority set for the schedule information.

A meeting setting method of receiving setting for a meeting according to the present disclosure includes: receiving an input; storing schedule information in which an attendee of a meeting is associated with a time; updating the schedule information in accordance with a result of the reception by the receiver; providing display related to the schedule information; and controlling the display provided by the displaying based on a display priority set for the schedule information.

A non-transitory computer-readable recording medium according to the present disclosure stores a meeting setting program that causes a computer to execute each step of the meeting setting method according to the present disclosure.

According to the present disclosure, setting for a meeting can be flexibly received by displaying appropriate candidates according to a display priority.

### BRIEF DESCRIPTION OF THE DRAWINGS

FIG. 1 is a schematic diagram illustrating a meeting setting system according to an embodiment of the present disclosure.

FIG. 2 is an explanatory table illustrating first schedule information.

FIG. 3 is a diagram illustrating an example of display provided by a display.

FIG. 4 is an explanatory table illustrating second schedule information.

FIG. 5 is a flowchart illustrating a processing flow for meeting setting, in the meeting setting system according to the embodiment of the present disclosure.

FIG. 6 is an explanatory table illustrating third schedule information.

FIG. 7 is an explanatory table illustrating fourth schedule information.

### DETAILED DESCRIPTION OF THE INVENTION

A meeting setting system according to an embodiment of the present disclosure will be described below with reference to drawings.

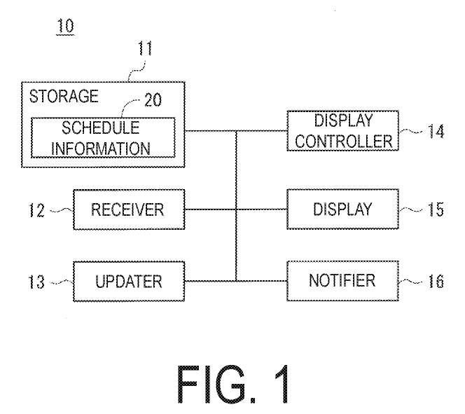

FIG. 1 is a schematic diagram illustrating the meeting setting system according to the embodiment of the present disclosure.

The meeting setting system 10 according to the embodiment of the present disclosure includes a storage 11, a receiver 12, an updater 13, a display controller 14, a display 15, and a notifier 16.

The meeting setting system 10 is a program (meeting setting program) stored in a terminal or the like connected via a network. The terminal that stores the meeting setting program is, for example, a meeting setting server, a mobile phone terminal, a tablet, a personal computer, or the like. The storage 11, the receiver 12, the updater 13, the display controller 14, the display 15, and the notifier 16 that are the components of the meeting setting system 10 do not need to be all integrated into one terminal, and may be provided in a corresponding terminal as appropriate.

The receiver 12 receives an input such as meeting setting from the user. The meeting setting includes items such as an attendee, a time, and a location of the meeting. The meeting setting, for which various designations may be received for the items, includes designations for mandatory attendance and optional attendance for the attendee of the meeting. The meeting settings may also include the designation of a substitute attendee related to the attendee of the meeting. This should not be construed in a limiting sense, and another designation may be received for the meeting setting.

The mandatory attendance designated indicates that the meeting is important for the attendee, and thus is preferably incorporated with a high priority, in a schedule determined. On the other hand, the optional attendance designated indicates that a meeting is not something that has to be attended by the attendee, and thus the priority thereof is preferably set to be lower than that for the mandatory attendance, in a schedule determined. The substitute attendee indicates an attendee who can attend the meeting on behalf of the designated attendee.

The storage 11 stores schedule information 20 in which an attendee of the meeting is associated with a time. The schedule information 20 may include a notification destination associated with an attendee of the meeting. For the sake of description, examples of the schedule information 20 may be referred to as first schedule information 20A to fourth schedule information 20D for distinction below.

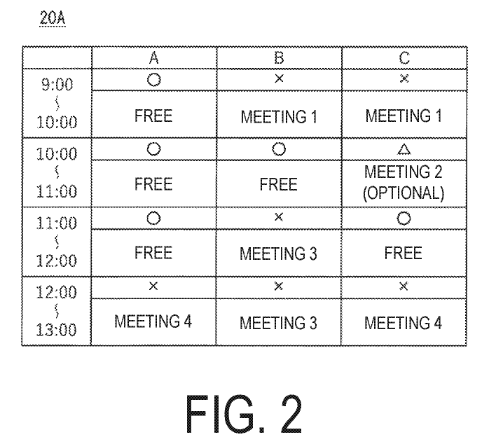

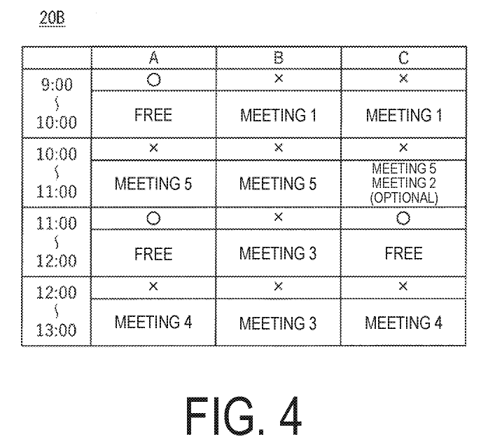

The updater 13 updates the schedule information 20 according to the result of the reception by the receiver 12. When the schedule information 20 is not stored in the storage 11, the schedule information 20 corresponding to the reception result may be created and stored in the storage 11. When the updater 13 updates the schedule information 20, the notifier 16 issues a notification indicating the update to the relevant notification destination. Note that the update of the schedule information 20 will be described with reference to FIGS. 2 and 4 described below.

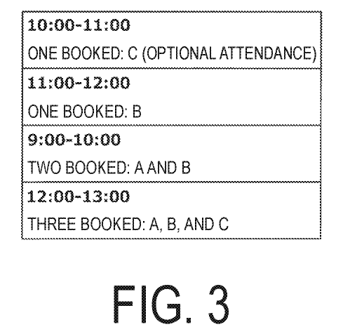

The display 15 provides display related to the schedule information 20. The display controller 14 controls the display provided by the display 15 based on the display priority set for the schedule information 20. An example of the display provided by the display 15 will be described with reference to FIG. 3 described below.

FIG. 2 is an explanatory table illustrating first schedule information.

In the schedule information 20, times set for the meetings are registered for a plurality of attendees. The first schedule information 20A illustrated in FIG. 2 includes schedules for three persons, that is, an attendee A, an attendee B, and an attendee C. A field for each time in the schedule information 20 includes an upper part describing a status of the field, and a lower part describing a detailed content of the field. The status of the field with the description "available" indicating that no meeting is set is indicated by the symbol "o". The status of the field for which the meeting of mandatory attendance is set is indicated by a symbol "x", and the status of the field for which the meeting of optional attendance is set is indicated by a symbol "Δ". The status of the field for which the meeting is set and the substitute attendee is designated is indicated by a symbol "□". For the sake of description, the schedule of the attendee may be indicated only by a symbol such as o or Δ below, with the description of the mandatory attendance or the optional attendance omitted.

In the first schedule information 20A, the schedule of the attendee A includes: FREE (o) set in the field of 9:00 to 12:00; and "MEETING 4 (x)", for which the mandatory attendance is designated, set in the field of 12:00 to 13:00. The schedule of the attendee B includes: "MEETING 1 (x)", for which mandatory attendance is designated, set in the field of 9:00 to 10:00; FREE (o) set in the field of 10:00 to 11:00; and "MEETING 3 (x)", for which mandatory attendance is designated, set in the field of 11:00 to 13:00. The schedule of the attendee C includes: "MEETING 1 (x)", for which mandatory attendance is designated, set in the field of 9:00 to 10:00; "MEETING 2 (Δ)", for which optional attendance is designated, set in the field of 10:00 to 11:00; FREE (o) set in the field of 11:00 to 12:00; and "MEETING 4 (x)", for which mandatory attendance is designated, set in the field of 12:00 to 13:00.

FIG. 3 is a diagram illustrating an example of display provided by a display.

FIG. 3 illustrates what is displayed when setting for a new meeting is received with the first schedule information 20A being the schedule information 20 stored in the storage 11. The display controller 14 refers to the first schedule information 20A and displays candidates for a time when the meeting is set based on the display priority. The highest display priority is given to a time in which all the attendees are free (FREE), the second highest display priority is given to a time in which a meeting is set involving an attendee for which optional attendance is designated, the third highest display priority is given to a time involving an attendee for which a substitute attendee is designated, and the lowest display priority is given to a time in which a meeting for which mandatory attendance is designated. Thus, using the status symbols, the relationship "o> Δ > □ > ×" holds.

Specifically, regarding the display priority in the first schedule information 20A, there is no time during which all the attendees (the attendee A, the attendee B, and the attendee C) are marked with o. Therefore, 10:00 to 11:00 which is the time during which all the attendees are marked with o or Δ is extracted and is displayed at the top. Next, times including those indicated by □ and × are searched for, and a time including a symbol corresponding to higher display priority is displayed at a higher level. As a result, 11:00 to 12:00, 9:00 to 10:00, and 12:00 to 13:00 are displayed in this order. The display contents are not limited to this, and the times of the same priority may be displayed side by side, and only a predetermined number of times with the highest display priorities may be displayed.

FIG. 4 is an explanatory table illustrating second schedule information.

FIG. 4 illustrates the second schedule information 20B as a result of updating the first schedule information 20A illustrated in FIG. 2. Specifically, the second schedule information 20B is updated from the first schedule information 20A, to include "MEETING 5 (x)" for which mandatory attendance is designated for the attendee A, the attendee B, and the attendee C in the field of 10:00 to 11:00. Regarding the attendee C, "MEETING 5 (x)" is added to the field of 10:00 to 11:00 in addition to "MEETING 2 (Δ)" that has been set before the update. For a time when an attendee has a plurality of meetings set, none of the meetings will be deleted. The status of such a time is given the lowest display priority. Thus, the status of the attendee C in the field of 10:00 to 11:00 is x since "MEETING 5 (x)" and "MEETING 2 (Δ)" are set. The notifier 16 notifies the attendee A, the attendee B, and the attendee C of the fact that "MEETING 5 (x)" is set.

In FIGS. 2 and 4, the case where the mandatory attendance is designated for all the attendees is described. However, this should not be construed in a limiting sense, and the setting may differ among attendees. For example, mandatory attendance and optional attendance may be individually set for each attendee.

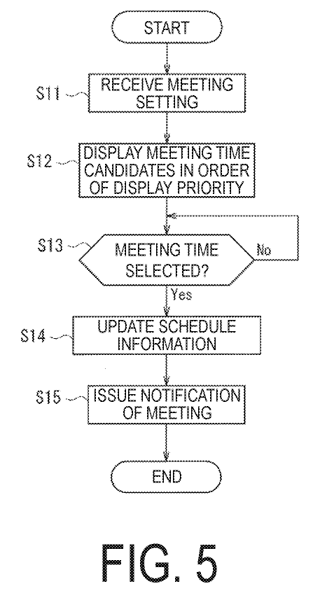

FIG. 5 is a flowchart illustrating a processing flow for meeting setting, in the meeting setting system according to the embodiment of the present disclosure.

In step S11, the receiver 12 receives meeting setting. Here, the attendee, the location, and the like of the meeting are received. In addition, designation of date and time, a time zone, or the like may be also received, and a time to be referred to may be limited according to the result of the reception.

In step S12, the display controller 14 displays the candidates for the meeting time in order of the display priority. Here, as described above, the display time candidates may be extracted with reference to the schedule information 20.

In step S13, whether the meeting time has been selected on the receiver 12 is determined. As a result, when the meeting time is selected (step S13: Yes), the processing proceeds to step S14. On the other hand, when the meeting time is not selected (step S13: No), the processing does not proceed until the meeting time is selected.

In step S14, the updater 13 updates the schedule information 20. The specific example here corresponds to processing of updating the first schedule information 20A to the second schedule information 20B as described above.

In step S15, the notifier 16 issues a notification of the meeting to the contact addresses of the attendee, and the processing ends. Thus, with the notifier 16, the attendees can be smoothly notified of an invitation to the meeting.

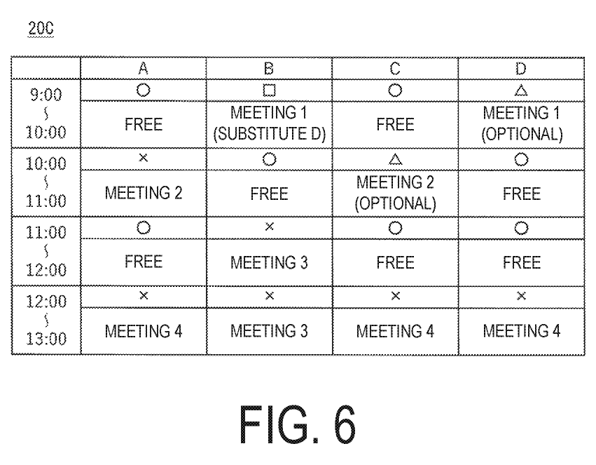

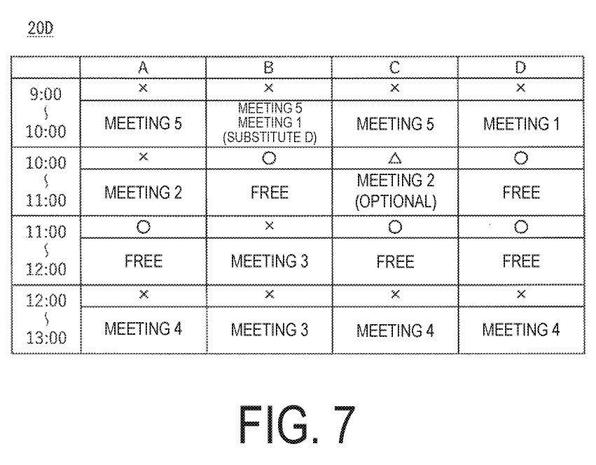

Next, another specific example of how the schedule information 20 is updated will be described with reference to FIGS. 6 and 7.

FIG. 6 is an explanatory table illustrating third schedule information, and FIG. 7 is an explanatory table illustrating fourth schedule information.

FIG. 6 illustrates the third schedule information 20C before update, and FIG. 7 illustrates the fourth schedule information 20D as a result of updating the third schedule information 20C. The third schedule information 20C and the fourth schedule information 20D include schedules of four persons, that is, the attendee A, the attendee B, the attendee C, and an attendee D.

In the third schedule information 20C, the schedule of the attendee A includes: FREE (o) set in the fields of 9:00 to 10:00 and 11:00 to 12:00; "MEETING 2 (x)", for which mandatory attendance is designated, set in the field of 10:00 to 11:00; and "MEETING 4 (x)", for which mandatory attendance is designated, set in the field of 12:00 to 13:00. The schedule of the attendee B includes: "MEETING 1 (□)", for which attendee D is designated as the substitute attendee, set in the field of 9:00 to 10:00; FREE (o) set in the field of 10:00 to 11:00; and "MEETING 3 (x)", for which mandatory attendance is designated, set in the field of 11:00 to 13:00. Furthermore, the schedule of the attendee C includes: FREE (o) set in the fields of 9:00 to 10:00 and 11:00 to 12:00; "MEETING 2 (Δ)", for which optional attendance is designated, set in the field of 10:00 to 11:00; and "MEETING 4 (x)", for which mandatory attendance is designated, set in the field of 12:00 to 13:00. The schedule of the attendee D includes: "MEETING 1 (Δ)", for which optional attendance is designated, set in the field of 9:00 to 10:00; FREE (o) set in the field of 10:00 to 12:00; and "MEETING 4 (x)", for which mandatory attendance is designated, set in the field of 12:00 to 13:00.

The fourth schedule information 20D is updated from the third schedule information 20C, to include "MEETING 5 (x)" for which mandatory attendance is designated for the attendee A, the attendee B, and the attendee C in the field of 9:00 to 10:00. Thus, the status of the attendee B in the field of 9:00 to 10:00 is x since "MEETING 5 (x)" and "MEETING 1 (Δ)" are set. The status of the attendee D in the field of 9:00 to 10:00 is x since "MEETING 1" is changed from optional attendance to mandatory attendance.

As described above, setting for a meeting can be flexibly received by displaying appropriate candidates according to a display priority. The display controller 14 provides the time designated for the attendee of the meeting in the display provided by the display 15. In this way, with the candidates including the time during which the meetings are double booked, it is possible to present the candidates for a wider range of selection.

In the present embodiment, a high display priority is set for a time for which optional attendance is designated, compared with a time for which mandatory attendance is designated. With whether the attendance of the meeting is mandatory or optional thus designated, a time to be preferentially displayed as a candidate can be appropriately selected. In addition, the display priority is set to be high for the time during which the substitute attendee is designated, compared with the time during which the optional attendance is designated. With the substitute attendee thus designated, a time to be preferentially displayed as a candidate can be appropriately selected.

Note that the embodiments disclosed herein are illustrative in all respects and do not form the basis for a limited interpretation. Accordingly, the technical scope of the present disclosure is not to be construed only by the foregoing embodiments and is defined based on the description of the claims. In addition, meanings equivalent to the claims and all changes made within the claims are included.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A meeting setting system that receives setting for a meeting, the meeting setting system comprising:
a receiver that receives an input;
a storage that stores schedule information in which an attendee of a meeting is associated with a time;
an updater that updates the schedule information in accordance with a result of the reception by the receiver;
a display that provides display related to the schedule information; and
a display controller that controls the display provided by the display based on a display priority set for the schedule information.

2. The meeting setting system according to claim 1, wherein the display controller provides the time designated for the attendee of the meeting, in the display provided by the display.

3. The meeting setting system according to claim 1, wherein
the setting for the meeting includes designation of mandatory attendance and optional attendance for the attendee of the meeting, and
the display priority is set to be high for a time for which the optional attendance is designated compared with a time for which the mandatory attendance is designated.

4. The meeting setting system according to claim 3, wherein
the setting for the meeting includes designation of a substitute attendee related to the attendee of the meeting,
the display priority is set to be high for a time for which the substitute attendee is designated, compared with a time for which the optional attendance is designated.

5. The meeting setting system according to claim 1, wherein
the schedule information includes a notification destination associated with the attendee of the meeting, and
the updater includes a notifier that issues a notification to the notification destination, when the updater updates the schedule information.

6. A meeting setting server that receives setting for a meeting, the meeting setting server comprising:
a receiver that receives an input;
a storage that stores schedule information in which an attendee of a meeting is associated with a time;
an updater that updates the schedule information in accordance with a result of the reception by the receiver;
a display that provides display related to the schedule information; and
a display controller that controls the display provided by the display based on a display priority set for the schedule information.

7. A meeting setting method of receiving setting for a meeting, the meeting setting method comprising:
receiving an input;
storing schedule information in which an attendee of a meeting is associated with a time;
updating the schedule information in accordance with a result of the reception by the receiver;
providing display related to the schedule information; and
controlling the display provided by the displaying based on a display priority set for the schedule information.
